(19) United States
(12) Patent Application Publication
(10) Pub. No.: US 2012/0169047 A1
(43) Pub. Date: Jul. 5, 2012

(54) METHOD OF FORMING AN INTERNAL TUBE BEADLOCK

(76) Inventors: Michael G. Arn, Van Wert, OH (US); Matt S. Hilvers, Ottoville, OH (US); Ron U. Rutschilling, Celina, OH (US)

(21) Appl. No.: 13/105,011

(22) Filed: May 11, 2011

Related U.S. Application Data
(63) Continuation-in-part of application No. 12/982,106, filed on Dec. 30, 2010.

(51) Int. Cl. F16L 13/14; B21D 39/04

(52) U.S. Cl. 285/382.4; 29/523

(57) ABSTRACT

A unique tube punch forming die assembly and process is disclosed for forming a bead lock on a malleable fluid conveyance tube which provides for the attachment of a fluid connector to the tube. The fluid connector is held in the tube punch forming die constituting a die assembly where a forming groove is machined in the internal cavity of the fluid connector for forming a bead lock within the inside of the fluid connector when the punch forming die is compressed into the tube. The tube is first inserted into the punch forming die, then the die is punched to buckle the tube to form a bead lock in the tube inside the fluid connector as the end of the tube held in a cylindrical support ring. In a second embodiment a plurality of serrations are formed inside the fluid connector and the tube is forced against the serrations to improve the retention of the tube.

### CROSS-REFERENCE TO RELATED APPLICATIONS

This application is a Continuation-in-part of application Ser. No. 12/982,106 filed on Dec. 30, 2010.

### TECHNICAL FIELD

A punch die holds a fluid connector for forming a bead lock on the end of a cylindrical tube internal to the fluid connector thereby eliminating the need for either brazing or post process plating.

### BACKGROUND

There are many applications in which a bead lock is formed at the end of a malleable cylindrical tube. Such bead locks are utilized to secure the tube to hoses or to some type of fluid device such as a hydraulic pump or valve. Such bead locked tubes are also used for securing tubes to systems carrying fluids such as fuel or brake fluids.

To form the bead lock on the end of a tube, it has been known to utilize a die assembly to radially deform and thereby expand the tube to form the bead lock separate from or external to the fluid connector. These die assemblies typically comprise a holder secured to the tube to prevent undesired axial movement of the tube relative to the die when the forming operation is performed. According to the prior art, the tubing holder and the forming die are moved together thereby radially expanding the tube into the forming surfaces formed on both the holder and the die separate from any type of fluid connector. The fluid connector is then joined to the longer tube by furnace brazing. In that process, the forming surface of the die would deform the surface of the bead lock axially closest to the free end of the tube while the forming surface on the tube holder would form the opposite axial end of the bead lock if one is needed. The heat applied during the brazing process causes the tube to deform slightly resulting in a misaligned assembly that must be either re-worked or discarded.

The disclosure of U.S. Pat. No. 6,572,358 to Blethen describes a die assembly for forming a bead lock on a cylindrical tube which includes a holder which secures the tube against axial movement so that a portion of the tube protrudes outwardly from the holder along a pre-determined axis and in which the holder has a forming surface which lies against the tube to be formed. The die assembly of the '358 patent further includes a first die part having a cylindrical mandrel aligned with and engaging with the tube. In its first position, the holder abuts against the second die part while the second die part is in its extended position. Conversely, as the holder is moved to its second position relative to the first die position the holder moves the second die part to its retracted position thus radially outwardly deforming the bead lock between the forming surface in the holder and the conical surface on the sleeve. Since the through bore formed in the second die part circumscribes and constrains the tube around the bead lock during the entire formation of the bead lock, and also since the holder remains in contact with the second die part during the entire deformation process, the bead lock is not only accurately formed on the tube, but the possibility of a burr forming between the holder and the second die part is altogether eliminated.

Thus, it is evident that while this prior art die assembly for forming a bead lock on a cylindrical tube produces a satisfactory product, it does so while using a very complicated and expensive piece of forming equipment separate from the fluid connector. More importantly, the bead locked tube is then brazed to a longer length of tubing and all of the assembled pieces must be thoroughly cleaned prior to the brazing process. The heat applied for brazing warps the components in an unpredictable manner requiring re-work or the parts to be discarded.

Another well known method of forming a bead lock on a cylindrical tube is disclosed in U.S. Pat. No. 3,575,033 to Meyer. In the '033 patent, a die member contains an annular passage that surrounds the exterior of a tube end and a guide pin that extends into the passage in the tube beyond the location of a desired bead lock. The tube is clamped into a holder at the approximate location of the bead lock and a force is applied to the die member to move the member toward the holder. This movement deforms the tube wall outward between the die member and the holder, thus forming a bead lock on the tube at a point remote from the tube end and separate from any type of fluid connector. This tubing bead locker does not control the outside diameter of the bead lock formed on the cylindrical tubing so that the process itself must be altered and changed to control the outside diameter of the bead lock by varying the degree that the die member is axially moved depending on the wall thickness and spring characteristics of the tube itself. Subsequently, the bead locked tube is assembled to a fluid connector and then brazed to a long tube.

The prior art processes includes cutting the unplated tubes to length; clean the components to prepare for brazing; form the outside diameter of the global nipple or other terminal fitting; furnace braze the joint; apply a trivalent plating to the joint; inspect for internal rust or corrosion and if required, sand blast and lube; end form the mating end per customer requirement; bend the assembly to print; and finally ship to stock.

### SUMMARY

The tube punch forming die of the present disclosure holds the fluid connector and a sizing mandrel that constitutes a die assembly. Using this punch die, a bead lock is formed internal to the fluid connector where a bead lock forming groove of the fluid connector closely controls the dimensions of the bead lock that is formed in the tubing that retains and seals the tube to the connector by performing the bead lock forming process inside the connector. The tube concurrently engages the sizing mandrel which maintains the minimum inside diameter of the tube as the bead lock is formed.

The inside contour of the cavity in the fluid coupling is designed to hold the open end of the tube in a support ring while the tube bead lock is formed by punching the die assembly while holding the end of the tube stationary in the fluid connector and allowing the side of the tube to buckle into the bead lock forming groove when the die is activated. The bead lock is formed inside the fluid connector and thus, the fluid connector is already assembled to the tube without a brazing operation which would require cleaning, heating and subsequent plating. In the process disclosed in this application, long sections of tube can be used without deformation over its length because brazing is not used to attach a bead locked tube to a longer section of straight tube. The present disclosure is a method of forming a bead lock inside a fluid connector having a hose nipple to retain the connector on a plated tube without using brazing.

The new process includes the following steps: cut tubing having a protective coating to length; end form mating end per customer requirement; end form hose end or other terminal end; bend the assembly to print; ship to stock. Or, in the alternative, cut the tubing to length and then apply a protective coating, connect end components having a protective coating, utilizing the exemplary bead lock process as disclosed herein, bend the assembly to print and ship to stock. The exemplary tube forming process is a two punch process where the first punch reduces the end diameter of the tube and can be performed on a Manchester end former or using some other type of tube former. The second punch uses a punch die which holds the fluid connector and installs the nipple and creates the bead lock internally in a bead lock forming groove formed inside the connector. Since there is no brazing or welding process involved, the tube remains basically straight since it is not subjected to high levels of heat. The absence of heat results in a relatively straight tube that can be accurately bent.

This new process also allows for the retention of rust inhibitors, oils or other surface treatments on the inside or on the outside of the tube to prevent corrosion. The use of brazing or welding would require that the tube be cleaned both internally and externally of all contamination if the braze or weld is going to be successful. Once the rust inhibitor, oil or other surface treatment is removed, rust can rapidly form and is considered a contaminant which has to be removed prior to use and is especially difficult to remove once the trivalent plating or other protective coating is applied. Any number of coatings, tube forming machines or auxillary processes can be utilized without departing from the teachings of this disclosure.

### BRIEF DESCRIPTION OF THE DRAWINGS

FIG. 1 is a cross-sectional view of the fluid conveyance tube after the end diameter of the tube has been reduced;

FIG. 2 is a cross-sectional view of the exemplary fluid connector and punch die and sizing mandrel;

FIG. 3 is a cross-sectional view of the tube just prior to insertion into the fluid connector and the sizing mandrel which are held by the punch die;

FIG. 4 is a cross-sectional view of the tube fully inserted into the fluid connector and into the sizing mandrel just prior to forming; and

FIG. 5 is a cross-sectional view of the tube with a formed bead lock inside the fluid connector and over the sizing mandrel.

FIG. 6 is a side perspective view of an alternate embodiment of the exemplary fluid connector;

FIG. 7 is a cross-sectional view of the alternate embodiment of the exemplary fluid connector of FIG. 6; and

FIG. 8 is a fragmentary cross-sectional view of a portion of the alternate embodiment of the exemplary fluid connector of FIG. 7.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description.

Moreover, a number of constants may be introduced in the discussion that follows. In some cases illustrative values of the constants are provided. In other cases, no specific values are given. The values of the constants will depend on characteristics of the associated hardware and the interrelationship of such characteristics with one another as well as environmental conditions and the operational conditions associated with the disclosed system. Any reference to a specific process, coating, or machine also includes all other types of like processes, coatings or machines.

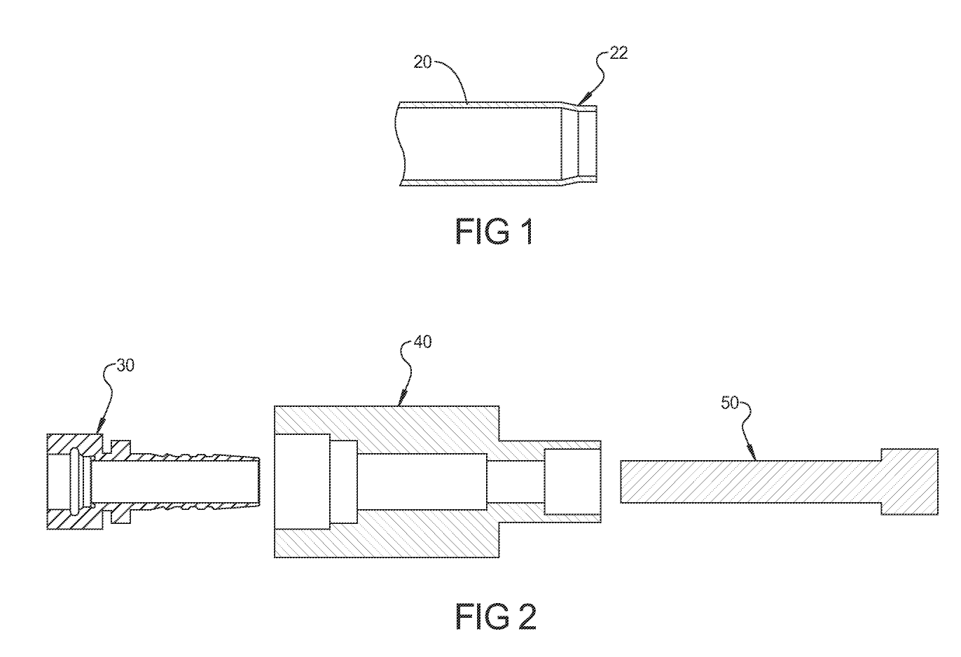

Now referring to FIG. 1 of the drawings, a partial cross-sectional view of a fluid conveyance tube 20 is shown after an end of the tube 20 has been “necked down” to a specified diameter using a first punch forming die or other tube forming process. A tube end forming machine such as a Manchester tubing forming machine can be used to neck down the tube 20. The tube 20 is preferably burr free and has an oil or other rust protection coating applied to its inner and outer surfaces. The tube 20 is preferably fabricated of some type of formable metal or metal alloy. Other protection coatings or plating processes can be used when using the exemplary bead lock forming process since no high heat is applied to the tubing unlike when brazing, soldering or welding is required.

Now referring to FIG. 2 of the drawings, a cross-sectional view of a fluid connector 30 and a second punch forming die 40 and a sizing mandrel 50 are shown. These three elements make up a die assembly. The fluid connector 30 is inserted into and is temporarily held by the second punch forming die 40 during a second punch forming process to form a bead lock 24 (see FIG. 5) on the tube 20. Prior to the second punch forming process, a sizing mandrel 50 is inserted into the forming die 40 and engages the inside diameter of the fluid connector 30 to maintain a minimum inside diameter of the tube 20 when the bead lock 24 is formed by hitting the punch die 40.

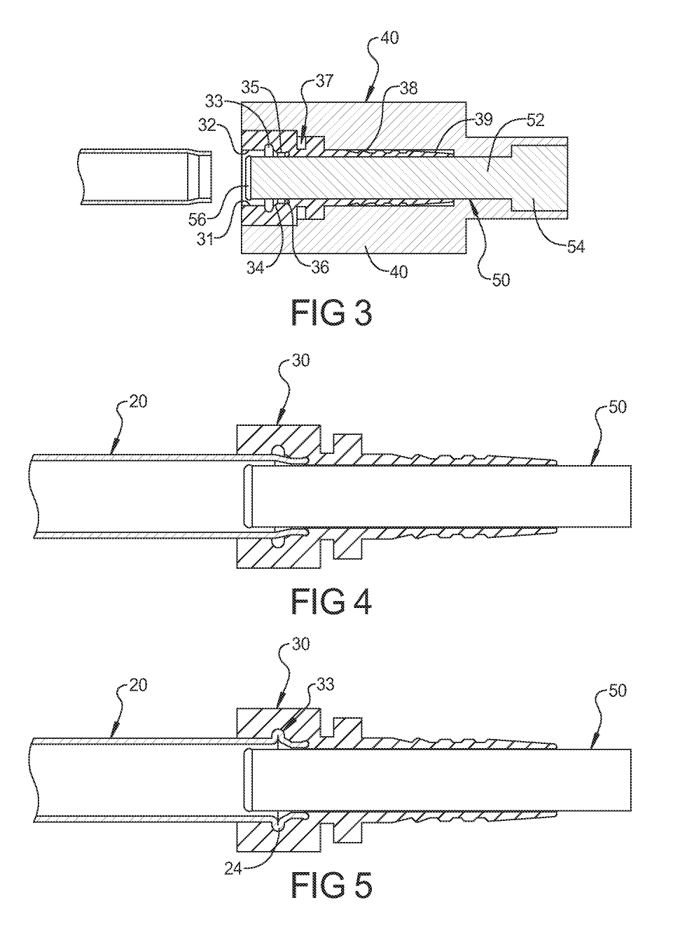

Now referring to FIG. 3 of the drawings, a cross-sectional view of the exemplary punch forming die 40 holding the fluid connector 30 and the sizing mandrel 50 making a die assembly 41 just prior to insertion and forming of a tube bead lock 24 on the tube 20 is shown. For clarity, the second punch forming die 40 is not shown which holds the fluid connector 30 and the sizing mandrel 50 as the tube 20 is inserted into the fluid fitting 30 and the punch die 40 is “hit”. The internal cavity of the fluid fitting 30 is shaped to accommodate the tube 20 and hold it in position as the second punch die 40 is hit to form the bead lock 24. Also not shown is some type of holding device for the tube 20 which must hold the tube 20 in relative position to the punch die 40 as the bead lock 24 is formed.

The inner cavity of the fluid connector 40 includes several individual cylindrically shaped cavities and surfaces. Lead section 32 guides the tube into the fluid connector 40 and over the sizing mandrel 50. Bead lock forming groove 33 is shaped so that the tube 20 buckles into the bead lock forming groove 33 to form a bead lock 24 having the desired dimensions. Chamfer section 34 allows the tube 20 to transition into the cylindrical support ring 35 just prior to the bead lock forming operation. The end of the tube 20 is held in the fluid connector 30 at end support 36 when the bead lock 24 is formed by impacting the punch die 40.

Now referring to FIG. 4 of the drawings, a cross-sectional view of the tube fully engaged in the second punch forming die 40 and over the sizing mandrel 50. The internal diameter of the tube 20 is opened up to a specified diameter when the sizing mandrel 50 is forced inside the tube 20 as the punch forming die 40 and the fluid connector 30 are forced into the end of the tube 20. The end of the tube 20 is shown as positioned against the end support 36 and has reached the end of its travel. Further movement of the punch forming die 40 would cause a buckling of the wall of the tube 20 into the inner cavities 32-36 of the fluid connector 30.

Now referring to FIG. 5 of the drawings, a cross-sectional view of the tube fully engaged with the second punch die 40 (see FIG. 3) and buckled at the bead lock 24 into the inner cavities 32-36 of the fluid connector 30 is shown. The inner cavity of the fluid connector 40 includes several individual cylindrically shaped cavities and surfaces. Lead section 32 guides the tube into the fluid connector 40 and over the sizing mandrel 50. Bead lock forming groove 33 is shaped so that the tube 20 buckles into the bead lock forming groove 33 to form a bead lock 24 having the desired dimensions. Chamfer section 34 allows the tube 20 to transition into the cylindrical support ring 35 just prior to the bead lock forming operation. Adjacent to the support ring 35 is an end support 36. The end of the tube 20 is held in the fluid connector 30 at the end support 36 when the bead lock 24 is formed by impacting the punch die 40. Upon impact of the second punch die 40, the wall of the tube 20 is buckled outward in a cylindrical fashion to occupy the bead lock forming groove 33. In this manner, the tube bead lock 24 has been formed while completely internalized inside the fluid connector 30 which is held in the punch forming die 40.

After the bead lock 24 is formed, the mandrel 50 is withdrawn and the punch die 40 is pulled away from the fluid connector 30 and the connected tube 20. The assembly is then ready for final bending of the tube and connection of a socket (not shown) to the socket groove 37 and then a hose (not shown) over the connector chamfer 39 and onto to the hose nipple 38. The socket is then crimped to apply a clamping force on the hose over the hose nipple 38. Many other types of terminal ends other than a hose nipple may be used with the exemplary connector 30. The bead lock 24 holds and seals the tube 20 to the fluid connector 30. Since no brazing is required, the inner and outer surface of the tube 20 and fluid connector 30 can be protected against corrosion before and after all forming operations.

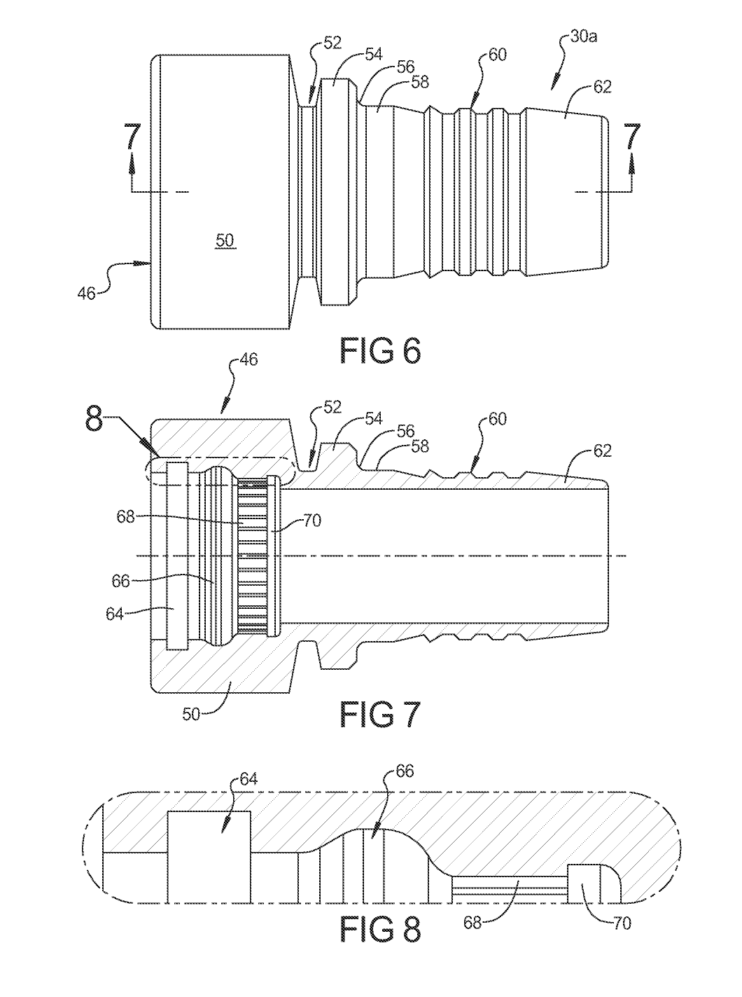

Now referring to FIG. 6 of the drawings, a side perspective view of an alternate embodiment of the fluid connector 30a. The connector 30a has a tube receiver 46 that is joined to a fitting section 48 where the tube receiver 46 is connected to the tube 20 at the tube collar 50. If a hose is to be connected to the connector 30a, a hose nipple type of terminal fitting as shown in FIG. 6 as fitting section 48 can be used. In this case, a socket groove 52 is formed between the tube receiver 46 and the fitting section 48 and is used to hold a socket (not shown) that is crimped onto a hydraulic hose (not shown) after it is installed onto the fitting section 48. The ring shaped stop collar 54 functions to stop the hose from being installed past the desired location on the nipple 48. Radius section 56 reduces the bending stress between the collar stop 54 and the flat transition section 58 by introducing a smooth radius between the stop collar 54 and the flat transition section 58. The ribs 60 formed on the outside of the fitting section 48 function along with the crimped socket (not shown) to retain the hydraulic hose onto the connector 30a. The installation of the hose is facilitated by the tapered end 62 on the fitting section 48 which is initially inserted into the hose and expands the inside diameter of the hose as it is pressed onto the fitting section 48. Note that many other types of terminal ends other than a hose nipple may be used for section 48. These other fittings can be used to join a second metal tube to plastic tube for example.

Now referring to FIG. 7 of the drawings, a cross-sectional view of the connector 30a is shown. The interior of the tube receiver 46 and specifically the tube collar 50. A seal cavity 64 is shown as a ring shaped void in the interior wall of the tube collar 50 and is designed to accept an O-ring type of sealing element. Other types of seals could be used and the design of the seal cavity 64 would have to be changed accordingly. This seal prevents contaminants from entering the interior of the connector 30a. The next interior cavity is a tube bead cavity 66 where the tube 20 buckles when it is pressed into the tube receiver 46 according to the process previously disclosed. Note that the mandrel 50 is used to prevent the tube 20 from collapsing inwardly when the tube 20 is pressed into the tube receiver 46. The bead lock 24 forms as the tube 20 expands into the tube bead cavity 66 and serves to retain the tube 20 in the connector 30a. A plurality of torsional serrations 68 are formed in the interior surface of the tube collar 50 adjacent to the tube bead cavity 66. These torsional serrations 68 bite into the outside of the tube 20 to assist in preventing the tube 20 from twisting in the connector 30a when it is subjected to torsional loads. A clearance groove 70 adjacent to the torsional serrations 68 to allow the tube 20 to be forced down into the clearance groove 70 by a punch. The punch seats the tube 20 in the clearance groove 70 and forces the tube 20 further into the serrations 68. This feature adds to the level of retention of the tube 20 in the connector 30a and increases the level of tolerance to torsional loads.

Now referring to FIG. 8 of the drawings, a cross-sectional view of a fraction of the alternate embodiment of the exemplary connector 30a is shown. The cross-section shown in FIG. 8 illustrates the seal cavity 64, the tube bead cavity 66, the torsional serrations 68, and the clearance groove 70. The tube 20 is pressed into the connector 30a until the tube 20 buckles and forms a bead in the tube bead cavity 66 (see FIG. 5 as an example). The mandrel 50 is placed inside the tube 20 prior to the press operation to keep the tube 20 from collapsing on itself. Another tool is used to press the end of the tube 20 into the clearance groove 70 and to press the side of the tube 20 into the torsional serrations 68. This operation securely attaches the tube 20 to the connector 30a. If a hose nipple is used for the terminal fitting section 48 as is shown in FIG. 8, the connector, it is now ready for installation of the hose onto the fitting section 48 over the ribs 60 and held by crimping of the socket (not shown) which is held within the socket groove 52.

The torsional serrations 68 can be shaped to bite against or slightly into the tube 20. Thus, the serrations 68 can be triangular in cross-section with a relatively sharp edge that contacts the tube 20. This triangular type shape is shown in FIGS. 7 and 8. Other cross-sectional shapes are contemplated so long as the edge of the torsional serrations 68 contact and torsionally grip the tube 20 to provide for a more secure retention of the tube 20 inside of the connector 30a.

The present disclosure has been particularly shown and described with reference to the foregoing illustrations, which are merely illustrative of the best modes for carrying out the disclosure. It should be understood by those skilled in the art that various alternatives to the illustrations of the disclosure described herein may be employed in practicing the disclosure without departing from the spirit and scope of the disclosure as defined in the following claims. It is intended that the following claims define the scope of the disclosure and that the method and apparatus within the scope of these claims and their equivalents be covered thereby. This description of the disclosure should be understood to include all novel and non-obvious combinations of elements described herein, and claims may be presented in this or a later application to any novel and non-obvious combination of these elements. Moreover, the foregoing illustrations are illustrative, and no single feature or element is essential to all possible combinations that may be claimed in this or a later application.

1. A method of forming a bead lock section on a metal tube comprising;
providing a malleable tube;
providing a sizing mandrel having an outside diameter equal to a selected inner diameter of said tube;
providing a fluid connector, said fluid connector having a bead forming groove in an internal cavity of said fluid connector;
providing a punch forming die, said forming die holding said fluid connector and said sizing mandrel in axial alignment;
inserting said tube inside said forming die to fully engage said internal cavity of said fluid connector, said tube also engaging said sizing mandrel to maintain said inside diameter of said tube; then
forcing said forming die onto said tube to force said tube to buckle and occupy the bead forming groove thereby forming a bead lock on said tube inside of said fluid connector.

2. The method of forming a bead lock section of claim 1 further comprising;
providing a first punch die reducing the outside diameter of said tube with said first punch die prior to inserting said tube into said forming die.

3. A fluid connector comprising;
a connector body having a central cavity;
a hose nipple formed on an outside surface of said connector body;
a cylindrical bead forming groove formed in said central cavity, said bead forming groove shaped to form a bead lock on a tube when said tube is forced into said fluid connector.

4. The fluid connector of claim 3 further comprising a cylindrical support ring for holding the end of said tube when said bead lock is formed.

5. The fluid connector of claim 3 further comprising a lead section at an end of the internal cavity of said fluid connector, said lead section adjacent to said bead forming groove.

6. The fluid connector of claim 5 further comprising a chamfer section disposed between said bead lock groove and said supporting ring.

7. The fluid connector of claim 5 further comprising a serrations section disposed adjacent to said bead lock groove.

8. A fluid connector for attachment to a malleable tube comprising;
a connector body having a central cavity;
a hose nipple formed on an outside surface of said connector body;
a cylindrical bead forming groove formed in said central cavity, said bead forming groove shaped to form a bead lock on a tube when said tube is forced into said fluid connector;
a cylindrical support ring for holding the end of said tube when said bead lock is formed;
a lead section at an end of the internal cavity of said fluid connector, said lead section adjacent to said bead forming groove;
a chamfer section disposed between said bead lock groove and said supporting ring; where said tube is forced into said fluid connector with an end of said tube engaging said support ring and said tube buckling to occupy said bead forming groove and thereby forming said bead lock to retain said tube to said fluid connector.

9. A fluid connector comprising:
A connector having a central cavity with a tube receiver section formed at a first end and a nipple section formed at a second end, said tube receiver section having a tube bead cavity formed into an inner surface of said tube receiver and a tube bead cavity disposed between said tube receiver section and said nipple section and having a torsional serrations section formed in said inner surface disposed between said tube bead cavity and said nipple section.

10. The fluid connector of claim 9, further comprising a seal cavity disposed between said first end and said tube bead cavity.

11. The fluid connector of claim 9 wherein said tube bead cavity is comprised of a plurality of radiused circumferential grooves.

12. The fluid connector of claim 9 wherein said serrations are formed to grip a metal tube.

13. The fluid connector of claim 13 wherein said serrations are approximately triangular in cross-section.

14. The fluid connector of claim 12 wherein said serrations have relatively sharp edges that contact said metal tube.

15. The fluid connector of claim 9 further comprising a clearance groove disposed between said torsional serrations and said nipple section, said clearance groove shaped to receive an end of said metal tube.

16. A method of retaining a metal tube in a fluid connector comprising:
Providing a metal tube for conveyance of a fluid;
Providing a fluid connector having a central passageway therethrough and having a tube receiving section joined to a nipple section where said tube receiving section has a seal cavity disposed adjacent to a first end of said tube receiving section and a torsional serration section disposed adjacent to said seal cavity and a tube bead cavity disposed adjacent to said tube bead cavity;
Inserting said tube into said fluid connector;
Inserting a mandrel into said nipple section through and into said metal tube past said tube bead cavity and then;
Pressing said tube into said fluid connector to outwardly collapse said tube into said tube bead cavity.

17. The method of retaining a metal tube in the fluid connector of claim 16, further comprising inserting a tool through said nipple section and into said metal tube and rolling said metal tube into said clearance groove and rolling said metal tube towards said torsional serrations.

18. The method of retaining a metal tube in the fluid connector of claim 16, further comprising inserting a punch type tool through said nipple section and into said metal tube and displacing said metal tube into said clearance groove and pushing said metal tube towards said torsional serrations.
